(19) United States
(12) Patent Application Publication
(10) Pub. No.: US 2005/0025108 A1
(43) Pub. Date: Feb. 3, 2005

(54) Method for the transmission of information in a cellular radio communication system with radio sectors

(76) Inventors: Markus Dillinger, Munchen (DE); Jijun Luo, Munchen (DE)

Correspondence Address: STAAS & HALSEY LLP, SUITE 700, 1201 NEW YORK AVENUE, N.W., WASHINGTON, DC, 20005, US

(21) Appl. No.: 10/495,791

(22) PCT Filed: Nov. 15, 2002
(86) PCT No.: PCT/EP02/12835

(30) Foreign Application Priority Data
Nov. 15, 2001 (EP) 01127170.7

(51) Int. Cl. H04B 7/216

(52) U.S. Cl. 370/342

(57) ABSTRACT

In a cellular radio communication system for several user stations, each radio cell in the radio communication system includes a base station by which the information is transmitted to user stations using broadcast and/or point to multipoint connections. At least two radio cells in the cellular radio communication system are each divided into n radio sectors with n≧2 and the information is transmitted in each of the n radio sectors of a radio cell with a temporal displacement to improve the interference situation. The information is advantageously transmitted in n radio sectors without any temporal overlap. Radio sectors can particularly advantageously be collected in a group, alternately including the lowest coupling factors with regard to radio transmission and transmitting the information for each group at a different time.

### CROSS REFERENCE TO RELATED APPLICATIONS

This application is based on and hereby claims priority to European Patent Application No. 01127170.7 filed on Nov. 15, 2001, the contents of which are hereby incorporated by reference.

### BACKGROUND OF THE INVENTION

1. Field of the Invention

The invention relates to a method for the transmission of information in a cellular radio communication system for several subscriber stations and to a radio communication system implementing the method.

2. Description of the Related Art

In radio communication systems, information (for example, voice, image information or other data) is transmitted with the aid of electromagnetic waves via a radio interface between a base station and a subscriber station (mobile station or terminal). The emission of the electromagnetic waves is carried out here using carrier frequencies which lie in the frequency band provided for the respective system. For future mobile radio communication systems using TD/CDMA transmission methods or FD/CDMA transmission methods via the radio interface, such as for example the UMTS system (universal mobile telecommunication system) or other third-generation systems, frequencies will be provided in the frequency band of approx. 2000 MHz.

For the aforementioned UMTS mobile radio communication system, a distinction is drawn between FDD mode (frequency division duplex) and TDD mode (time division duplex). TDD mode is characterized in particular in that a common frequency band is used both for up-link (UL) and down-link (DL) signal transmission, while FDD mode uses a different frequency band for each of the two transmission directions.

The information to be transmitted within the radio communication system can be transmitted via various connections. Information which is specifically designated to one subscriber station is transmitted using point-to-point connections over dedicated channels. Information which is intended for all subscribers (broadcast information) or for a specified class of subscribers (multicast information) in a radio cell is transmitted using broadcast or point-to-multipoint connections. Each radio cell in the radio communication system includes a base station by which the information is transmitted down-link to subscriber stations. In addition to these down-link information transmissions, up-link transmissions from subscriber stations to the base stations also take place.

The base station can emit the information via sectorial antennae. The radio cell is then subdivided into individual radio sectors corresponding to the sectorial antennae.

In contrast to the transmission of information via point-to-point connections over dedicated channels, the transmission of information for several subscribers over broadcast channels is not load-controlled. Due in particular to this fact, a significant deterioration in the interference situation results where regular traffic is concerned if, in addition to the transmissions via point-to-point connections, information for several subscriber stations is also transmitted without load control.

### SUMMARY OF THE INVENTION

An object of the present invention is to indicate a method and a radio communication system of the type described in the introduction which will provide a positive influence on the interference situation. Recourse is to be made, in particular, to a system for the transmission of non-load-controlled information for several subscribers.

According to the invention, at least two radio cells in the cellular radio communication system are each divided into n radio sectors, whereby n stands for the number of radio sectors with a value of at least 2. The information is transmitted in each of the n radio sectors of a radio cell with a temporal displacement.

In particular, the information can be transmitted in each of the n radio sectors of a radio cell without any temporal overlap, preferably in directly connected time phases.

This means that the transmission of information for all n radio sectors of a radio cell requires at least n times the time needed for the transmission in one radio sector. If the information is transmitted without any temporal overlap in directly connected time phases, this gives a total required transmission time per radio cell of n time phases.

The temporally differentiated transmission of information contributes noticeably to an improvement in the interference situation. A particularly effective measure for improving the interference situation relies on collecting the radio sectors of at least two radio cells in each case into a group, alternately including the lowest coupling factors with regard to radio transmission, and in transmitting the information for each group at a different time.

In a design of the invention, the grouping with regard to the alternately lowest coupling factors is carried out at least in one area of the radio communication system. Such areas of the radio communication system can be chosen such that they are oriented toward the infrastructural situation of the radio communication system. Thus, for example, those radio sectors whose base stations are assigned to one base-station controller can be collected into a group.

In a further development of the invention, the grouping with regard to the alternating lowest coupling factors can essentially correspond to a grouping according to the alignment of the transmit signals from the base stations for transmission of the information. The alignment of the transmit signals from the base stations can be considered here in particular in a spatial sense and/or in terms of the polarization of the transmit signals.

The information for several subscribers can include software, in particular for downloading a version upgrade, which can turn out to be relatively time-consuming. In particular, a comprehensive version upgrade can be carried out using the proposed method. Use of the invention here keeps the interference to regular traffic within the cell to a low level.

Mobile stations or terminals, for example, can be used as subscriber stations. The subscriber stations can, for example, be reconfigured by downloading network software (core software). The type of download here can vary from simple parameters, preferably for applications or services, to immediately executable program codes. The downloaded software can be received in various formats, for example, as hardware-specific binary codes, as high-level software which still has to be interpreted, as software objects or as software agents.

In a design of the invention, in particular n=2, n=3, n=4 or n=6 can be chosen as the number of radio sectors. Such a number of radio sectors on the one hand leads through use of the invention to a significant reduction in the interference that occurs while on the other hand enabling the organization of the transmission of information to be accomplished with a relatively low outlay.

Due to the fact that the broadcast channels are not load-controlled, it is generally guaranteed that the subscriber stations can receive the information. In the event that the information to be transmitted is not received in full by a subscriber station, the remaining information can in a further development of the invention be transmitted to this subscriber station over a dedicated channel. Such a situation can, for example, arise if a mobile station, on account of its mobility, moves out of the radio sector while receiving the information. If therefore, as in the case described, the information to be transmitted is not received in full by the subscriber station on account of the mobility of the subscriber station, for example, where a handover to a different radio sector of the same or of a different radio cell is concerned, the remaining information to be transmitted is transmitted to this subscriber station over a dedicated channel. Other reasons for incomplete transmission, such as faults, are also possible.

The invention can be used in particular for transmission using a CDMA (code division multiple access) method. The invention leads namely to a noticeable improvement in the frequency situation, in particular in radio communication systems where identical frequencies are used in adjacent cells. This applies to radio communication systems using the CDMA method Raising the transmit power in a cell makes it necessary to raise the transmit power in

The adjacent cell if a defined signal-to-interference ratio (SIR) is to be maintained for services.

However, the invention also brings an improvement in the interference situation for radio communication systems with a frequency re-use factor greater than 1.

The transmission of information is not restricted within the scope of the present invention to the simultaneous transmission of information in adjacent cells, rather it also covers the simultaneous transmission of information to non-adjacent cells.

In order to implement the invention in practice, the cellular radio communication system must carry out the method according to the invention. This may be accomplished in a network controller controlling the transmission of information for several subscriber stations.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a schematic or block diagram of an area of a radio communication system with a large number of radio sectors divided into three groups.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

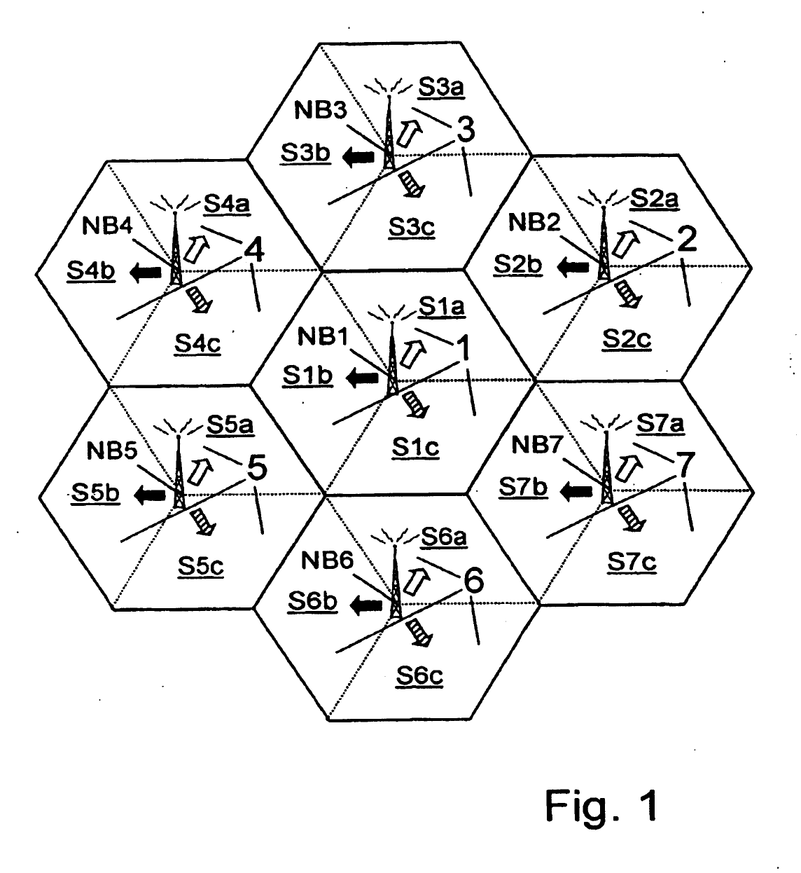

The layout shown in FIG. 1 shows an area of a radio communication system of 7 radio cells 1-7, each with 3 radio sectors SXa, SXb and SXc with X=1 to 7. The base stations NBX with X=1 to 7 of each radio cell 1-7 transmit to the respective radio sectors SXa, SXb and SXc via sectorial antennae which cover a range of about 120 degrees.

The radio sectors SXa of the radio cells 1-7 are collected in a first group. The radio sectors SXb and SXc form further groups. The radio sectors of each of these groups alternately exhibit the lowest coupling factors with regard to radio transmission.

In respect of the transmission of information for subscriber stations in the radio cells 1-7, for example in respect of the parallel downloading of software, then in the event that for example information transmission without any temporal overlap is required, the information is first transmitted to radio sectors S1a, S2a and S3a, S4a, S5a, S6a and S7a. After the downloading of the first group (indicated with a white arrow) in the radio sectors Sxa is complete, the information is transmitted in the radio sectors S1b, S2b, S3b, S4b, S5b, S6b and S7b (second group with black arrow). Lastly, the information is transmitted in the sectors S1c, S2c, S3c, S4c, S5c, S6c and S7c (third group with hatched arrow).

This procedure can also be repeated cyclically.

Using simulations, it was possible to show in respect of this embodiment that the interference situation within the radio cells could be substantially improved by the invention. Thus it emerged, for example, that, given 20 subscriber stations in each cell, for about 90% of subscribers the invention results in a reduction in the mean interference in respect of regular traffic in the range of about 7.5 dB. Furthermore, the fact that the regular traffic reacts to the reduced mean interference resulting from the invention with a load control, namely a load reduction, has a positive effect here. This effect increases as the number of subscribers per cell increases.

The number of the n radio sectors to be chosen can be made dependent on various factors, for example on the average size of the information to be transmitted and/or on real-time requirements.

The invention has been described in detail with particular reference to preferred embodiments thereof and examples, but it will be understood that variations and modifications can be effected within the spirit and scope of the invention.

1-11. (cancelled).

12. A method for transmission of information in a cellular radio communication system to a plurality of subscriber stations, each radio cell in the cellular radio communication system including a base station by which the information is transmitted to the subscriber stations using at least one of broadcast and point-to-multipoint transmission, said method comprising:
dividing each of at least two radio cells in the cellular radio communication system into n radio sectors, where n≧2; and
transmitting the information in each of the n radio sectors within each radio cell with a temporal displacement.

13. A method according to claim 12, wherein said transmitting transmits the information in each of the n radio sectors within each radio cell without any temporal overlap in adjacent time phases.

14. A method according to claim 13,
further comprising collecting the radio sectors in each of the at least two radio cells in groups which alternately include lowest coupling factors with regard to radio transmission, and
wherein said transmitting of the information is carried out for each group at a different time.

15. A method according to claim 14, wherein said collecting is implemented at least in one area of the cellular radio communication system.

16. A method according to claim 15, wherein said collecting groups the radio cells according to alignment of transmit signals transmitting the information from the base station of each radio cell.

17. A method according to claim 16, wherein the information includes a version upgrade of software downloaded to the subscriber stations.

18. A method according to claim 16, wherein the information includes parameters for at least one of applications and services.

19. A method according to claim 16, further comprising setting n equal to one of 2, 3, 4 and 6.

20. A method according to claim 16, wherein said transmitting transmits remaining information over a dedicated channel when the information to be transmitted has not been received in full by a subscriber station.

21. A method according to claim 16, wherein said transmitting is carried out by a CDMA multiple-access method.

22. A cellular radio communication system for transmission of information to a plurality of subscriber stations, each radio cell in the cellular radio communication system including a base station by which the information is transmitted to the subscriber stations using at least one of broadcast and point-to-multipoint transmission, comprising:
a network controller controlling transmission of the information for several subscriber stations by dividing each of at least two radio cells in the cellular radio communication system into n radio sectors, where n≧2 and transmitting the information in each of the n radio sectors within each radio cell with a temporal displacement.

23. A cellular radio communication system according to claim 22, wherein said network controller controls transmission of the information in each of the n radio sectors within each radio cell to occur without any temporal overlap in adjacent time phases.

24. A cellular radio communication system according to claim 23,
wherein said network controller further controls collecting the radio sectors in each of the at least two radio cells in groups which alternately include lowest coupling factors with regard to radio transmission, and
wherein said network controller controls the transmission of the information to occur at a different time for each group.

25. A cellular radio communication system according to claim 24, wherein said network controller controls the collecting to group the radio cells according to alignment of transmit signals transmitting the information from the base station of each radio cell.

26. A cellular radio communication system according to claim 25, wherein the information includes a version upgrade of software downloaded to the subscriber stations.

27. A cellular radio communication system according to claim 25, wherein the information includes parameters for at least one of applications and services.

28. A cellular radio communication system according to claim 25, wherein said network controller further sets n equal to one of 2, 3, 4 and 6.

29. A cellular radio communication system according to claim 25, wherein said network controller controls the transmitting to transmit remaining information over a dedicated channel when the information to be transmitted has not been received in full by a subscriber station.

30. A cellular radio communication system according to claim 25, wherein the transmitting uses a CDMA multiple-access method.
